(19) United States
(12) Patent Application Publication
(10) Pub. No.: US 2024/0217187 A1
(43) Pub. Date: Jul. 4, 2024

(54) Sealing Tool Having A Heating Means

(71) Applicant: GEA Food Solutions Germany GmbH, Biedenkopf-Wallau (DE)

(72) Inventor: Reiner Paul, Dautphetal-Elmshausen (DE)

(21) Appl. No.: 18/013,009

(22) PCT Filed: Jun. 29, 2021
(86) PCT No.: PCT/EP2021/067903

§ 371 Date: Dec. 27, 2022

(30) Foreign Application Priority Data
Jul. 1, 2020 (DE) 10 2020 208 238.3

(51) Int. Cl. B29C 65/00; B29C 51/10; B29C 51/42; B29C 65/18; B65B 9/04; B65B 47/02; B65B 47/08; B65B 51/14; B65B 59/00; B65B 59/02; B65G 15/64

(52) U.S. Cl. CPC B29C 66/849; B29C 51/10; B29C 51/422; B29C 65/18; B29C 66/53461; B29C 66/841; B29C 66/8432; B65B 9/04; B65B 47/02; B65B 47/08; B65B 51/14; B65B 59/003; B65B 59/02; B65G 15/64; B29C 2793/009

(57) ABSTRACT

A sealing or moulding tool of a packaging machine having a heating element with a heating plate provided on a carrier and covered with a cover element, wherein the cover element is connected to the carrier by means of a plurality of connecting means.

### CROSS REFERENCE TO RELATED APPLICATIONS

This application is a US National Stage of PCT/EP2021/067903 filed on Jun. 29, 2021, and which claims priority to DE 10 2020 208 238.3 filed on Jul. 1, 2020, all of which are hereby incorporated by reference herein for all purposes.

### FIELD

The present invention relates to a sealing or moulding tool of a packaging machine. Furthermore, the present invention relates to a packaging machine having a moulding station, which forms recesses into a lower material web, wherein a heating element heats the lower material web before and/or during the deformation, and a sealing station, which connects an upper material web to the lower material web and has a heating element for this purpose.

### BACKGROUND

Class-specific packaging machines are known from prior art. In these packaging machines, a recess is formed in a flat material web, for example a film web, by deep drawing. For this purpose, the material web must be heated with a heating element before deep drawing. During deep drawing, the material web is subjected to different stresses. Especially in the area of corners and in the edge area, the material web is stretched much more than, for example, at the bottom of the recess or in the area of the sealing seam. To prevent the material from becoming too thin in these areas, thicker material webs are used, which has a particularly negative effect on the cost, transport and disposal of the packaging to be produced. During sealing, too, the two material webs must be heated exactly but only locally, if possible.

### SUMMARY

It was therefore the object of the present invention to provide a sealing or moulding tool and a packaging machine which do not have the disadvantages of the prior art.

The object is solved by a sealing or moulding tool of a packaging machine having a heating element with a heating plate provided on a carrier and covered with a cover element, wherein the cover element is connected to the carrier by means of a plurality of connecting means.

The explanations given with respect to this subject matter of the present invention apply equally to the other subject matters and vice versa. Features of this subject matter of the present invention may be incorporated into other subject matters and vice versa.

This subject matter of the present invention relates to a sealing or moulding tool of a packaging machine with a heating element having a heating plate provided on a carrier.

A heating plate within the meaning of the invention is not necessarily, but preferably, a flat two-dimensional object. It can also be curved or otherwise formed 3-dimensionally. The heating plate can be located in the sealing tool and/or in the moulding tool and here in particular in the upper tool and/or upstream of the moulding tool, relative to the transport direction of the lower material web. The heating plate can be connected directly to the carrier. Preferably, however, thermal insulation is provided between the heating plate and the carrier, for example of a very strong, thermally insulating material. Alternatively, the heating plate itself consists at least substantially of thermal insulation. Preferably, the heating plate consists of a heating film. On the side of the heating element facing the material web to be heated, the heating element has a cover element, preferably made of a material with good thermal conductivity, in particular metal, preferably aluminum or stainless steel. Preferably, there is direct and preferably full-surface contact between the heating plate and the cover element. Accordingly, the heating element preferably consists of a heating plate, a carrier and a cover element, wherein, in addition, thermal insulation may be provided between the carrier and the heating plate, or the carrier may be at least partially designed as thermal insulation.

According to the invention, the cover element is connected to the carrier and/or to the insulation by means of a plurality of connecting means. The connecting means are preferably arranged in such a way that there is no contact with the material web.

Preferably, the cover element is a film or plate, in particular a sheet or a sheet film, preferably an aluminum sheet or an aluminum film, the edge area of which is preferably flanged or bent or edged at least in sections. Preferably, the cover element is provided as a porous component.

The cover element can be manufactured as a 3D-printed part. Preferably, the material thickness, in particular the sheet thickness of the cover element, is 0.2-2 mm. This range has proven to be particularly advantageous because with a smaller material thickness, especially aluminum sheet thickness, the cover element tends to warp and/or the heat capacity of the cover element is too low, while with a greater material thickness the desired temperature profile becomes blurred.

Preferably, the connecting means are provided in the flanged/bent/edged section of the cover element. Alternatively or additionally or particularly preferably, the connecting means are provided on the back side of the cover element, in particular on that part of the back side which extends parallel to the film web.

Preferably, sleeves and/or bolts and/or nuts, in particular sleeves/bolts with a thread, are provided on the cover element. The sleeves, bolts and/or nuts are connected to the cover element, in particular by a welded and/or bonded connection. The sleeves may have an internal or external thread. The connecting means are preferably connected with a screw with an internal or external thread. Instead of the screw, a nail can also be used, but this may have the disadvantage that the connection is more difficult to undo. The fastener may also be a riveted connection, such as a connection with blind or pop rivets. A connecting means within the meaning of the invention is not a material connection. The connection between the covering means and the carrier is preferably provided in such a way that the covering means is clamped against the heating plate. A heat-conducting layer, in particular an elastic one, can be provided between the cover element and the heating plate.

Preferably, the connecting elements are provided according to a grid, in particular equidistantly.

Preferably, the carrier is a thermal insulation material. Preferably, the carrier and/or the thermal insulation provided between the carrier and the heating plate is not provided in one piece but in multiple pieces, in particular as a plurality of plate segments. Preferably, the dimensions of at least two segments, preferably all segments, are identical. Preferably, a gap is provided between the segments. A gap is particularly advantageous if it can prevent mutual interference between the segments as a result of thermal expansion, especially of different thermal expansion. Preferably, at least one, preferably several channels are provided in the carrier and/or the thermal insulation, through which a gas can be routed in order to suck the material web onto the covering element and/or to blow out a gas with which the material web is formed. Preferably, the carrier and/or the thermal insulation have at least one cable routing channel. In the case of several channels, these are preferably arranged according to a grid, in particular equidistantly.

The cover element can have cutouts, in particular in a preferably uniform grid, by means of which a negative and/or positive pressure can be generated between the cover element and the material web.

The heating plate is preferably an electric heating plate, wherein the power supply is preferably routed through the carrier and any thermal insulation present, and/or is provided through the carrier and/or the thermal insulation, for example inductively.

Preferably, a connecting means extending at least partially through the thermal insulation and/or the carrier is provided on the cover element and is preferably connectable to the thermal insulation and/or the carrier. The connecting means is preferably located on the side of the cover element facing away from the material web and particularly preferably at a distance from the cover element's edge area, preferably in the area of its center or in the area of one or more symmetry axes.

A further preferred or inventive subject matter of the present invention is a sealing or moulding tool with which packaging recesses or packaging of different cross-sections and/or sealing seams of different shapes are produced and which has a heating plate, wherein the heating plate has a conducting path pattern consisting of a plurality of L-shaped conducting paths per recess/packaging to be produced.

The explanations given with respect to this subject matter of the present invention apply equally to the other subject matters and vice versa. Features of this subject matter of the present invention may be incorporated into other subject matters and vice versa.

According to this subject matter of the present invention, material webs can be locally heated with the same heating plate in such a way that packaging recesses with a different cross-section, i.e. with different dimensions of the packaging in length and/or width, and/or sealing seams with a different shape/geometry can be produced. For this purpose, the conductor plate preferably has a plurality of conducting path patterns, each of which has a plurality of conducting paths, for example straight and/or L-shaped conducting paths or a combination thereof. Several straight and/or L-shaped conductive paths are preferably used per packaging recess or sealing seam.

Bridging elements can be provided between two L-shaped conductive paths at one or both ends, which can be electrically controlled together with the adjacent L-shaped conductive path or separately from it. Several conductive paths can be controlled individually and/or in groups.

Another preferred or inventive subject matter of the present invention is a sealing or moulding tool in which the heating plate is constructed from a plurality of, preferably identical, modules.

The explanations given with respect to this subject matter of the present invention apply equally to the other subject matters and vice versa. Features of this subject matter of the present invention may be incorporated into other subject matters and vice versa.

According to the invention or preferably, the heating plate is constructed from several modules which are arranged next to each other, preferably in one plane. Each module is preferably rectangular, in particular square. The extension transverse to the transport direction resulting from the modules arranged next to each other is preferably greater than the useful width of the material web. The extension in the transport direction resulting from the modules arranged next to each other is preferably greater than or equal to the forward pull in the case of an intermittently transported material web.

Preferably, the extension transverse to the transport direction resulting from the modules arranged next to each other is greater than the distance between the transport means, in particular greater than the distance between the clamping means arranged on the transport means, which clamping means grip the material web.

Each module is preferably individually electrically connected and individually controllable/adjustable.

Each module preferably has a grid/pixel pattern of local heating points/pixels, each of which can be electrically controlled separately or in groups/as a group.

Preferably, there is a gap between the modules, in particular a gap running around the respective module, between the modules of a heating plate.

Particularly preferably, this gap is at least in part completely sealed in such a way that no noteworthy air flow passes through the gap, especially in the case of backside gassing of the conductor plates, for example with compressed air. Preferably, the seal between two modules is provided elastically. For example, the seal is made of a rubber-like material.

Preferably, at least one module, preferably each module, has a cutout, preferably a circular cutout, through which a gas can be extracted and/or blown in the direction of the material web.

A further subject matter of the present invention is a packaging machine having a moulding station, which forms recesses into a lower material web, wherein a heating element heats the lower material web before and/or during the deformation, and a sealing station, which connects an upper material web to the lower material web and has a heating element for this purpose, wherein the heating elements of the moulding station and of the sealing station are of at least substantially, preferably completely, identical construction.

The explanations given with respect to this subject matter of the present invention apply equally to the other subject matters and vice versa. Features of this subject matter of the present invention may be incorporated into other subject matters and vice versa.

This subject matter of the present invention relates to a packaging machine for producing a packaging, in which a lower material web, for example, a plastic film or a material web having in particular a cardboard, paper or other non-plastic layer, is unrolled from a supply roll and transported preferably intermittently/cyclically along the packaging machine in a transport plane. In a moulding station, this lower material web will then first be formed by means of a deep drawing tool, for example to form a recess and/or a structure, in particular an anti-slip structure, in the lower material web. The moulding station usually has a lower tool and an upper tool which are moved towards each other for forming and away from each other for further transport of the lower material web. The lower tool is located below and the upper tool above the transport plane of the lower material web. As a rule, several packagings arranged in a so-called format are processed simultaneously in the packaging machine according to the invention and are subsequently transported simultaneously along the packaging machine.

Before and/or during deep drawing, the lower material web is heated with a heating element. Subsequently, the lower material web is loaded with a material to be packaged, in particular a food product such as sausage, ham or cheese, and in a next step is sealed with an upper film in a sealing station, wherein the upper film is usually sealed to the lower film web. A heating element is used for this purpose, which provides the thermal energy required for sealing. Subsequently, the packaging thus completed is separated by cutting out the packaging from the lower and upper material webs. The upper material web is also unrolled from a supply roll. In relation to the transport direction of the respective film web, downstream of at least one supply roll there is preferably a dancer which keeps the tension in the respective material web at least substantially constant. The dancer can be a linear dancer or a rotational dancer.

According to the invention, at least substantially identical heating elements, in particular identical heating plates, are used for the moulding station and for the sealing station. The heating plates can each be constructed from several modules, in particular identical modules, which are provided next to each other in one plane. Preferably, the heating elements have identical carriers and/or identical thermal insulation and/or cover elements.

A further subject matter of the present invention is a packaging machine having a moulding station which forms recesses into a lower material web, wherein a heating element heats the lower material web before and/or during the deformation, and/or a sealing station which connects an upper material web to the lower material web and has a heating element for this purpose, and having transport means which transport the lower material web in a transport direction, wherein the transport means are provided at a distance transverse to the transport direction, and the extension of the heating element transverse to the transport direction is > than the distance of the transport means.

The explanations given with respect to this subject matter of the present invention apply equally to the other subject matters and vice versa. Features of this subject matter of the present invention may be incorporated into other subject matters and vice versa.

In this subject matter of the present invention, the extension of the heating element transverse to the transport direction of the material web is greater than the distance of the two transport means to the right and left of the material web transporting the material web and/or greater than the distance of the clamping means provided on the transport means.

Preferably, the heating plate and/or its modules can be controlled in such a way that, preferably at least, the area of the heating element that overlaps the transport means and/or the clamping means is not heated.

Another subject matter of the present invention is a packaging machine having a moulding station which forms recesses into a lower material web, wherein a heating element heats the lower material web before and/or during the deformation, and/or having a sealing station which connects an upper material web to the lower material web and has a heating element for this purpose, and having transport means which transport the lower material web in a transport direction, wherein the lower material web has a usable width, wherein the extension of the heating element transverse to the transport direction is ≥ than the usable width.

The explanations given with respect to this subject matter of the present invention apply equally to the other subject matters and vice versa. Features of this subject matter of the present invention may be incorporated into other subject matters and vice versa.

In this subject matter of the present invention, the extension of the heating means transverse to the transport direction of the material web is greater than or equal to the useful width of the material web transverse to the transport direction. Preferably, the extension of the heating element transverse to the transport direction is greater than the distance between the transport means, in particular greater than the distance between the clamping means arranged on the transport means, which clamping means grip the material web. The usable width is the material web width minus an edge strip on the right and left in relation to the transport direction, which is required for gripping the material web or for holes for the gas exchange.

Preferably, the heating element is controllable so that the area of the heating element that exceeds the usable width is not heated.

A further subject matter of the present invention is a method for producing a packaging, in particular with the packaging machine according to the invention described herein, in which a material web is formed by means of compressed air, wherein the compressed air is blown through the heating plate.

The explanations given with respect to this subject matter of the present invention apply equally to the other subject matters and vice versa. Features of this subject matter of the present invention may be incorporated into other subject matters and vice versa.

In this embodiment of the present invention, the heating element is located inside the moulding tool, in particular in the area of the upper tool, and the forming of the material web into a packaging recess is effected and/or assisted by compressed air acting on the material web from above. According to the invention, this compressed air now flows through the heating plate. For this purpose, the heating plate has one or more cutouts, for example bores. Alternatively or additionally, the compressed air flows through one or more gaps between two modules of which the heating plate consists and/or through a gap running around the outer modules.

Preferably, the compressed air is heated, i.e. it has a temperature >20° C. This heating is particularly preferably not effected exclusively by the heating element.

### BRIEF DESCRIPTION OF THE FIGURES

The invention is explained below with reference to FIGS. 1 to 8. These explanations are merely exemplary and do not limit the general idea of the invention.

FIG. 1 schematically shows the packaging machine according to the invention.

FIGS. 2a-d show different formats of packaging recesses

FIGS. 3-5 show further embodiments of the packaging machine.

FIG. 6 shows a heating element according to the invention

FIGS. 7a and 7b show two possible formats

FIGS. 7c and 7d show two embodiments of the heating plate

FIGS. 7e and 7f show the control of the conductive path pattern according to FIG. 7d.

FIG. 8 shows an embodiment of the heating element.

### DETAILED DESCRIPTION

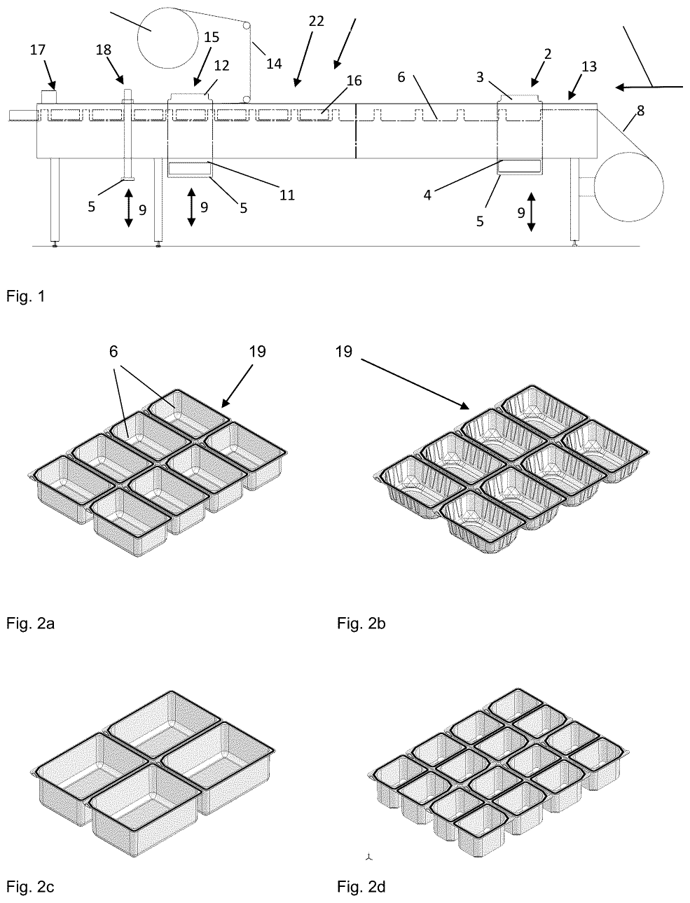

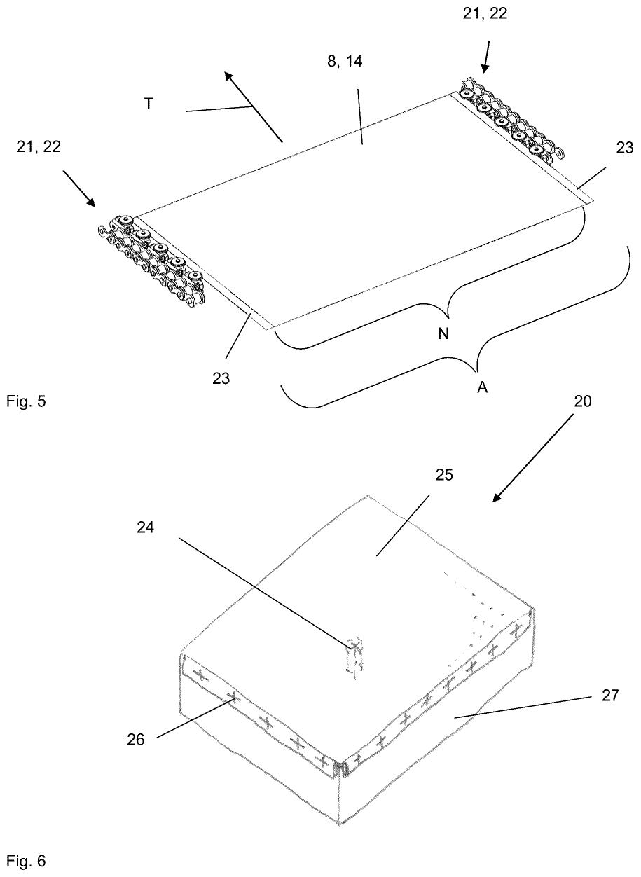

FIG. 1 shows the packaging machine 1 according to the invention, which optionally has a moulding station 2, a filling station 7 and a sealing station 15. The packaging machine can be a so-called thermoformer or a so-called traysealer. A lower material web 8, in this case a plastic film 8, is pulled off a supply roll and transported from right to left in cycles along the packaging machine according to the invention. In each cycle, the bottom material web 8 is advanced by one format length/feed length. For this purpose, the packaging machine has two transport means 21 (see FIG. 5), in the present case respectively two endless chains, which are arranged to the right and left of the lower material web 8. Both at the beginning and at the end of the packaging machine, respectively at least one gear is provided for each chain, around which the respective chain is redirected. At least one of these gears is driven. The gears in the inlet section and/or in the outlet section can be connected to each other, preferably by a rigid shaft. Each transport means 21 has a plurality of clamping means/grippers 22 which grip the lower material web 8 in a clamping manner in the infeed area and transfer the movement of the transport means to the lower material web 8. In the outfeed area of the packaging machine, the clamping connection between the transport means and the lower material web 8 is released again. Downstream of the infeed area, a heating element can be provided to heat the lower material web 8, especially when it is standing still. The moulding station 2 has a lower tool 4 and an upper tool 3. The lower tool 4 can be moved up and down as indicated by the double arrow, wherein it is moved upward toward the lower material web 8 for forming and downward for further transport of the lower material web 8. In the raised position, the lower material web is preferably clamped between the two tools 3, 4. The lower tool 4 can be located on a lifting table 5, which, as symbolized by the double arrow, can be vertically adjustable to produce the lower tool movement described above. In the further course of the packaging machine, the packaging recesses 6 formed in the lower material web as indicated here or the lower material web 8 are then loaded with the material to be packaged 16 in the filling station 7. In the sealing station 15 following downstream therefrom, which also consists of an upper tool 12 and a, if applicable, vertically adjustable lower tool 11, an upper film 14 is attached to the lower material web 8 in a material-bonding manner by sealing. Thereby, the movement of the lower material web 8 is transferred to the upper material web 14. In the sealing station, too, the upper tool and/or optionally the lower tool are lowered or raised before and after each film transport. The upper film 14 can also be guided in transport means or transported by transport chains, wherein these transport means then only extend before the sealing station and, if applicable, upstream.

Otherwise, the explanations given for the transport means of the bottom film apply. The upper film can also be heated and/or deep drawn with heating element. For sealing, the lower tool 11 is provided, for example, as a sealing frame which has an opening for each packaging recess into which the, if applicable, present packaging recess dips during sealing, i.e. during the upward movement of the lower sealing tool. For sealing, the upper and lower material webs are pressed together between the upper and lower tools 12, 11 and bond under the influence of heat and pressure. After sealing, the tools 11, 12 are moved apart again vertically. A dancer, for example, a rotary dancer, which keeps the material web 14 at a constant tension to the extent possible, can be provided between the supply roll of the upper material web 14 and the sealing tool. The person skilled in the art understands that a dancer is also preferably provided in the area of the lower material web 8, preferably downstream of the supply roll. Preferably, the dancer is a linear dancer. A gas exchange preferably takes place in each packaging recess before and/or during the sealing of the upper material web to the lower material web. For this purpose, the air present in the packaging recess is first partially extracted and/or replaced by an exchange gas. For this purpose, holes can be made in the area of each format in the lower material web 8 in the area of the transport chains, through which holes the air between the material webs 8, 14 is extracted and/or the exchange gas is blown in. In the further course of the packaging machine, the completed packagings are separated, which, for example, is done with the traverse cutter 18 and the longitudinal cutter 17. In the present case, the transverse cutter 18 can also be raised or lowered by means of a lifting device 9. According to another embodiment, the sealing tool 11, 12 has a punch which severs the lower and upper material webs before, during and/or after sealing.

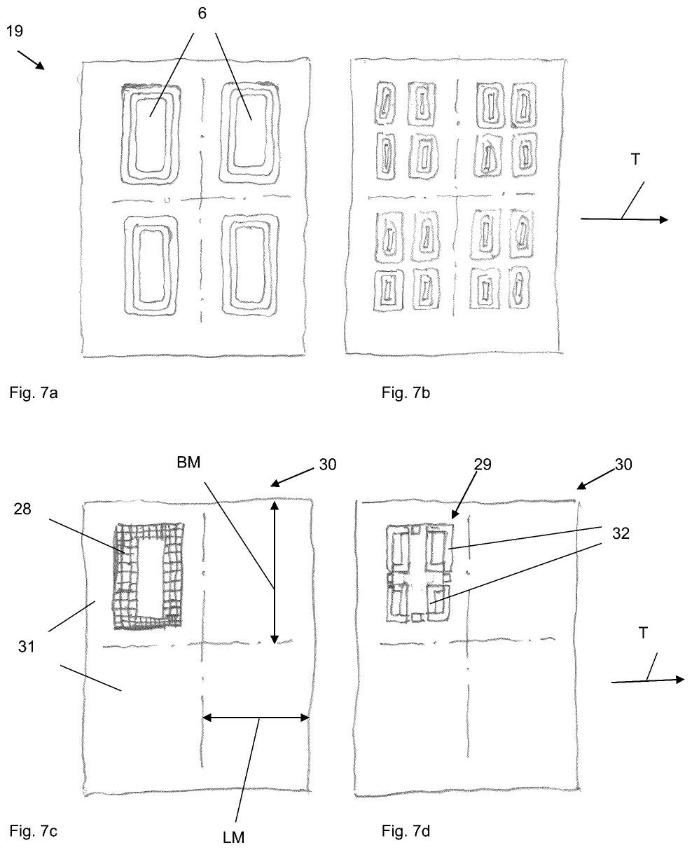

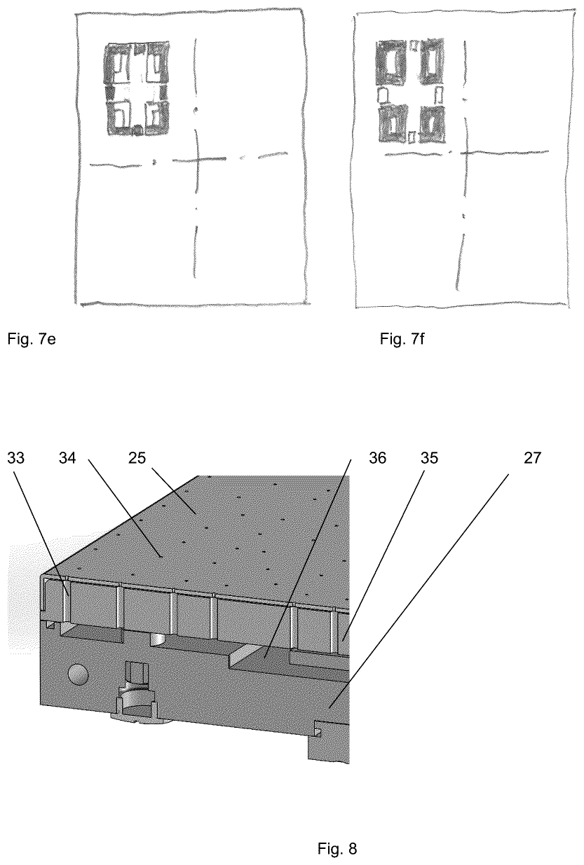

Preferably, each cycle produces several packagings simultaneously, arranged as matrix in a so-called format. Such formats are shown in FIGS. 2a-2d, 7a and 7b.

FIGS. 2a to 2d show four different formats that can be produced when the material web 8 is pulled forward. Preferably, the heating element or the packaging machine is provided in such a way that all shown formats 19 of packaging recesses 6 or packaging can be produced without having to replace the heating element 20 in the sealing station 15 or the upper tool 12 or the heating in the area of the moulding station.

The adjustment of the control of the heating plate is preferably automatic, in particular computer-controlled.

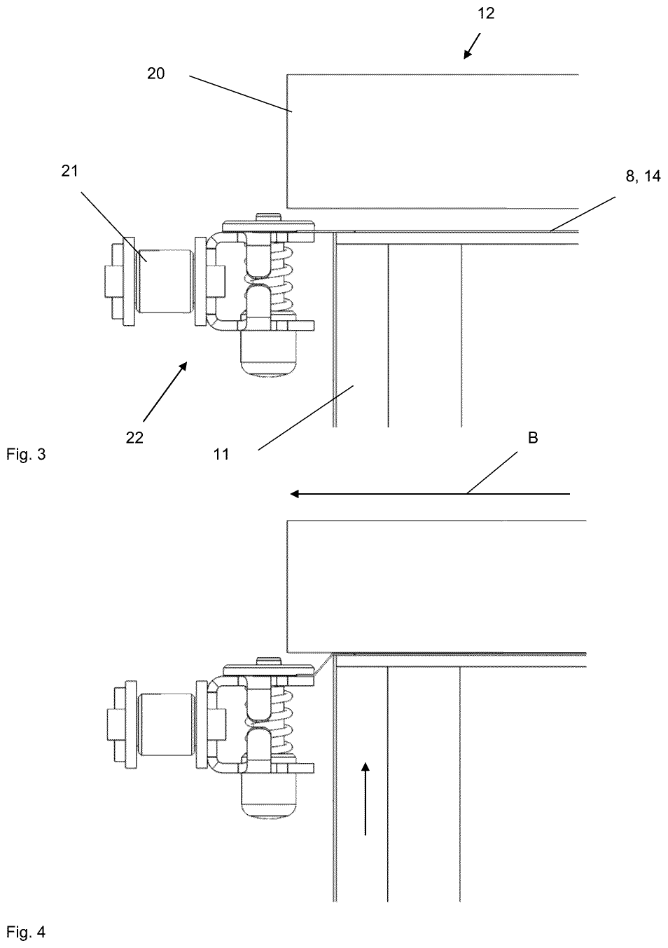

FIGS. 3 and 4 show an embodiment of the packaging machine according to the invention. The material web 8 or webs 8, 14 are transported on the right and left along the packaging machine by a transport means 21, in this case a chain 21, on which gripper or clamping means 22 are provided. The width of the heating element 20 is provided now in such a way that it is larger than the distance A between the clamping means 22 to each other, so that the heating element 20, at least partially overhangs at least the clamping means or the grippers 22, respectively. In the present case, the heating element 20 is provided to be stationary. The lower tool 11 is raised for sealing (see FIG. 4). The heating element is preferably provided in such a way that no heating energy is released in the area covering the transport chain and/or the clamping means 22.

FIG. 5 shows a further embodiment of the packaging machine according to the invention. In the present case, too, a web of material 8, 14 is transported along the packaging machine in transport direction T. The material web 8, 14 is gripped in its lateral edge area by a transport means 21, 22, respectively, and transported further. For this gripping, or in order to also be able to provide cutouts for a gas exchange if necessary, the material web has an edge strip 23 on the right and left in each case, which cannot be used for the production of packaging. Accordingly, the material web 8, 14 has a usable width N. According to an inventive or preferred embodiment, the width B of the heating element, i.e. its extension transverse to the transport direction T of the material web, is provided wider than the usable width N of the material web 8, 14. Preferably, the heating plate can be controlled in such a way that no or only a small amount of heating energy is released despite the covering in the area of the edge strips 23.

FIG. 6 shows an embodiment of the heating element, which in the present case has a carrier 27, a heating plate (not shown) and a cover element 25, preferably a metal plate, in particular a stainless steel plate. The cover element 25 is located on the side facing the material web. The cover element 25 can have cutouts (not shown) through which a negative and/or positive pressure can be generated between the cover element and the material web to be heated. Accordingly, the negative or positive pressure is preferably also present between the cover element 25 and the heating plate located therebehind. Preferably, the cover element is flanged or bent in its edge area.

This flanged or bent area is then connected to the carrier or to the insulation layer, if present, preferably reversibly, for example by screws.

On its side facing the heating plates, the cover element can have a connecting means 24, for example a welding stud 24, which extends at least partially through the carrier 27 and with which the cover 25 can be connected to the carrier, in particular reversibly. The connecting means, which is located in an area of the cover element remote from the edge area, can prevent the cover from moving away from the heating plate, in particular from pulsating or vibrating, during heating of the material web and/or during sealing.

FIGS. 7a and 7b once again show two different formats of packaging recesses and packaging, respectively, which are produced when the material web is pulled forward. In the left embodiment, four packaging recesses are produced simultaneously, and in the right embodiment, sixteen packaging recesses are produced simultaneously.

FIGS. 7c and 7d show two possible embodiments of a heating plate with which the formats according to FIGS. 7a and 7b can be produced without a modification of the heating elements, whereby for the sake of simplicity the heating plate is only shown in one quadrant. In the embodiment according to FIG. 7c, the heating plate has a plurality of pixels which are preferably distributed evenly, in particular equidistantly, over the heating plate. The pixels can be controlled and heated individually or in groups to create the desired heating profile. In FIG. 7c, the pixels are shown as a grid in the upper left quadrant, which are controlled to produce a packaging recess according to FIG. 7a in such a way that the temperature profile required for production is generated in the material web. The person skilled in the art understands that the same applies to making the weld seam. Preferably, the heating plate is composed of modules, in particular identical modules, each having a width BM or a length LM. The modules are preferably arranged butt to butt in one plane. In the present case, four modules are shown, which form the heating plate. The width BM or length LM can be the same or different. In particular, the width BM of the module can be selected so that its multiple does not correspond to the usable width N of the material web 8, 14. Preferably, one module is used to heat an area of the material web sufficient for the production of several packagings. Alternatively, two modules are required to heat the material web to produce a single packaging.

FIG. 7d shows another embodiment of the heating plate. In the present case, the heater plate has a pattern 29 of conductive paths, each of which can preferably be controlled individually or as a group. Preferably, each pattern consists of a plurality of L-shaped conductive paths 32. Bridging conductive paths can be provided at one or both ends of an L in each case. The person skilled in the art understands that these conductive paths are present in each quadrant of the heater plate according to FIG. 7d.

The control of the conductive path pattern 29 according to FIG. 7d is shown in FIGS. 7e and 7f. To produce a packaging recess 6 or a sealed seam according to embodiment 7a, the four outer L-shaped conductive paths and the bridging elements located therebetween are electrically controlled, while no voltage is applied to the inner L-shaped elements. To produce the format or the associated sealing seams shown in FIG. 7b, the four outer L-shaped conductive paths, but now also the four inner L-shaped conductive paths, are electrically controlled, while the bridging elements are not supplied with voltage in the present case.

By a simple change of the control, it is possible to switch from one packaging form to the other.

FIG. 8 shows an embodiment of the heating element 20 according to the invention, which in the present case has a cover element 25 and a carrier plate 27. In the present case, a thermal insulation 35 is provided between the cover element 25 and the carrier plate 27. The heating modules (not shown) are located between the thermal insulation 35 and the cover element. The thermal insulation is preferably composed of several segments. In the present case, gas channels 33 are provided in the thermal insulation 35, which are in connection with bores 34 in the covering means. A gas, preferably air, can be sucked in or blown out through the gas channels 33 and the bores 34. The person skilled in the art understands that the heating plate, which is located between the covering means 25 and the thermal insulation, must also be corresponding gas channels, which are preferably provided congruently with the channels 33, 34. In the present case, gas collection channels are provided in the carrier plate to direct a gas toward or away from the channels 33.

The cover plate is connected to the carrier plate by means of screws.

### REFERENCE SYMBOL LIST

1 Packaging machine
2 Moulding station, deep drawing station
3 Upper tool of the moulding station, upper tool of the deep drawing station
4 Lower tool of the moulding station, upper tool of the deep drawing station
5 Lifting table, carrier of a tool of the sealing station, deep drawing station and/or cutting device
6 Carrier of the material to be packaged, packaging recess, lower tray, tray
7 Filling station, inserting station
8 Material web, lower material web
9 Lifting device
10 Punching means
11 Lower tool of the sealing station
12 Upper tool of the sealing station, sealing tool
13 Preheater (for example upstream of the moulding station)
14 Upper material web, cover material web
15 Sealing station
16 Material to be packaged
17 Longitudinal cutter
18 Transverse cutter
19 Format
20 Heating element
21 Transport means, chain
22 Clamping means, gripper
23 Edge strip
24 Connecting means
25 Cover element
26 Connecting means, screw
27 Carrier
28 Pixel pattern, pixel
29 Conducting path pattern
30 Heating plate
31 Module
32 Conductive path, L-shaped conductive path
33 Gas channel
34 Gas outlet opening
35 Insulation
36 Gas collection channel
N Usable width
A Distance of the transport means
B Dimension of the heating plate transverse to the transport direction of the web
BM Dimension of module, width of module
LM Dimension of module, length of module
T Transport direction of the material web

1. A sealing or moulding tool of a packaging machine having a heating element with a heating plate provided on a carrier and covered with a cover element, wherein the cover element is connected to the carrier by means of a plurality of connecting means.

2. The sealing or moulding tool according to claim 1, wherein a connecting means is provided on the covering element, which at least partially protrudes through a thermal insulation and/or the carrier.

3. The sealing or moulding tool according to claim 1, wherein packaging recesses or packaging of different cross-section and/or sealing seams of different shape are produced and which has the heating plate, wherein the heating plate has a conducting path pattern having a plurality of L-shaped conducting paths per recess/packaging to be produced.

4. The sealing or moulding tool according to claim 3, wherein several conductive paths can be controlled individually and/or in groups.

5. The sealing or moulding tool according to claim 1, wherein the heating plate is constructed from a plurality of identical, modules.

6. The sealing or moulding tool according to claim 5, wherein there is a gap between the modules which is preferably sealed with an elastic material.

7. A packaging machine having a moulding station which forms recesses into a lower material web, wherein a heating element-heats the lower material web before and/or during the deformation, and/or having a sealing station which connects an upper material web to the lower material web and has heating elements for this purpose, wherein the heating elements are of at least substantially identical construction.

8. The A packaging machine having a moulding station which forms recesses into a lower material web, wherein a heating element heats the lower material web before and/or during the deformation, and/or having a sealing station which connects an upper material web to the lower material web and has a heating element for this purpose, and having transport means which transport the lower material web in a transport direction, wherein the transport means are provided at a distance transverse to the transport direction, wherein an extension of the heating element transverse to the transport direction is than the distance.

9. A packaging machine having a moulding station which forms recesses into a lower material web, wherein a heating element heats the lower material web before and/or during the deformation, and/or having a sealing station which connects an upper material web to the lower material web and has a heating element for this purpose, and having transport means which transport the lower material web in a transport direction, wherein the lower material web has a usable width, wherein an extension of the heating element transverse to the transport direction is ≥ than the width.

10. A method for producing a packaging, with the packaging machine according to claim 7, in which the lower material web is formed by means of compressed air, wherein the compressed air is blown through a heating plate.

11. The method according to claim 10, wherein the compressed air is heated.
